(19) United States
(12) Patent Application Publication
(10) Pub. No.: US 2017/0060801 A1
(43) Pub. Date: Mar. 2, 2017

(54) SEMICONDUCTOR SYSTEM AND CONTROLLING METHOD THEREOF

(71) Applicant: SK hynix Inc., Icheon-si Gyeonggi-do (KR)

(72) Inventor: Dong Uk LEE, Icheon-si Gyeonggi-do (KR)

(21) Appl. No.: 15/046,551

(22) Filed: Feb. 18, 2016

(30) Foreign Application Priority Data
Aug. 31, 2015 (KR) 10-2015-0123095

(51) Int. Cl. G06F 13/40; G06F 13/16

(52) U.S. Cl. CPC G06F 13/4068; G06F 13/1673

(57) ABSTRACT

A semiconductor system may include a controller, a buffer chip electrically coupled to the controller, and a plurality of memory chips electrically coupled to the buffer chip, each memory chip including at least one chip data terminal. The buffer chip may be configured to perform logic operations on data output from at least one pair of chip data terminals among the plurality of memory chips, and to output the logic operation results to the controller or provide the logic operation results to other chip data terminals among the plurality of memory chips other than the at least one pair of chip data terminals which output the data.

### CROSS-REFERENCES TO RELATED APPLICATION

This application claims priority under 35 U.S.C. 119(a) to Korean application No. 10-2015-0123095, filed on Aug. 31, 2015, in the Korean intellectual property Office, which is incorporated by reference in its entirety as set forth in full.

### BACKGROUND

1. Technical Field

Various embodiments generally relate to a semiconductor integrated circuit, and more particularly, to a semiconductor system and a controlling method thereof.

2. Related Art

Semiconductor apparatuses may be coupled to a controller. The controller may be configured to control the semiconductor apparatuses. In general, the semiconductor system may include the semiconductor apparatus and the controller.

Due to high-speed trends regarding the semiconductor systems, the semiconductor apparatuses and the controllers may also be designed to have a high processing rate.

To speed up the semiconductor systems, research on high-speed operations of the semiconductor apparatuses and the controllers and high-speed signal processing of the semiconductor apparatuses and the controllers has been performed and continues to be researched.

### SUMMARY

According to an embodiment, there may be provided a semiconductor system. The semiconductor system may include a controller, and a buffer chip electrically coupled to the controller. The semiconductor system may include a plurality of memory chips electrically coupled to the buffer chip. The buffer chip may be configured to perform logic operations on data output from at least one pair of memory chips among the plurality of memory chips and to output the logic operation results to the controller or provide the logic operation results to other memory chips among the plurality of memory chips other than the at least one pair of memory chips which output the data.

According to an embodiment, there may be provided a method of controlling a semiconductor system. The method may include outputting data from a first memory chip and data from a second memory chip. The method may include determining whether or not to perform an operation. The method may include providing the data output from the first memory chip and the data output from the second memory chip to a controller when it is determined that the operation is not performed. The method may include performing a first operation and a second operation on the data output from the first memory chip and the data output from the second memory chip when it is determined that the operation is performed. The method may include selecting memory chips to which results of the first operation and the second operation are to be transferred.

According to an embodiment, there may be provided a semiconductor system. The semiconductor system may include a controller, and a buffer chip electrically coupled to the controller. The semiconductor system may include a plurality of memory chips electrically coupled to the buffer chip, each memory chip including at least one chip data terminal. The buffer may be configured to perform logic operations on data output from at least one pair of chip data terminals among the plurality of memory chips, and to output the logic operation results to the controller or provide the logic operation results to other chip data terminals among the plurality of memory chips other than the at least one pair of chip data terminals which output the data.

According to an embodiment, there may be provided a method of controlling a semiconductor system. The method may include outputting data from a first data chip terminal and a second data chip terminal. The method may include determining whether or not to perform an operation. The method may include providing the data output from the first data chip terminal and the data output from the second data chip terminal to a controller when it is determined that the operation is not performed. The method may include performing a first operation and a second operation on the data output from the first data chip terminal and the data output from the second data chip terminal when it is determined that the operation is performed. The method may include selecting data chip terminals to which results of the first operation and the second operation are to be transferred.

### BRIEF DESCRIPTION OF THE DRAWINGS

FIG. 1 is a configuration diagram illustrating a representation of an example of a semiconductor system according to an embodiment.

FIG. 2 is a diagram illustrating a representation of an example of a configuration of a buffer chip and memory chips of the semiconductor system of FIG. 1.

FIG. 3 is a configuration diagram illustrating a representation of an example of a first operation controller of FIG. 2.

FIG. 4 is a configuration diagram illustrating a representation of an example of a first input/output (I/O) controller of FIG. 2.

FIG. 5 is a configuration diagram illustrating a representation of an example of a first channel data transfer circuit of FIG. 2.

FIG. 6 is a diagram illustrating a representation of an example of a configuration of a buffer chip and memory chips of the semiconductor system of FIG. 1.

FIG. 7 is a flowchart illustrating a representation of an example of a controlling method of a semiconductor system according to an embodiment.

### DETAILED DESCRIPTION

Hereinafter, examples of embodiments will be described below with reference to the accompanying drawings. Examples of embodiments are described herein with reference to cross-sectional illustrations that are schematic illustrations of examples of embodiments (and intermediate structures). As such, variations from the shapes of the illustrations as a result, for example, of manufacturing techniques and/or tolerances, are to be expected. Thus, examples of embodiments should not be construed as limited to the particular shapes of regions illustrated herein but may be to include deviations in shapes that result, for example, from manufacturing. In the drawings, lengths and sizes of layers and regions may be exaggerated for clarity. Like reference numerals in the drawings denote like elements. It is also understood that when a layer is referred to as being “on” another layer or substrate, it can be directly on the other or substrate, or intervening layers may also be present.

Although a few embodiments will be illustrated and described, it will be appreciated by those of ordinary skill in the art that changes may be made in these examples of embodiments without departing from the principles and spirit of the descriptions.

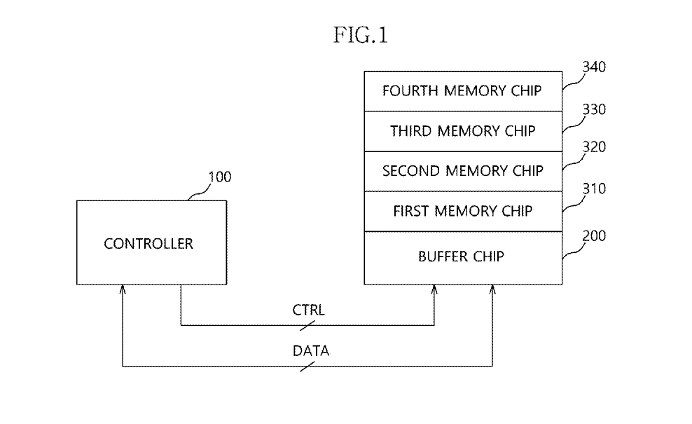

Referring to FIG. 1, a semiconductor system according to an embodiment may include a controller 100, a buffer chip 200, and first to fourth memory chips 310, 320, 330, and 340. The first to fourth memory chips 310 to 340, that is, four memory chips are illustrated in FIG. 1, but the number of memory chips is not limited thereto. Referring to FIG. 1, the first to fourth memory chips 310, 320, 330, and 340 are stacked over the buffer chip 200 however, the first to fourth memory chips 310, 320, 330, and 340 and buffer chip may be positioned differently and some or all may not be stacked with one another.

The controller 100 may be electrically coupled to the buffer chip 200. The controller 100 may provide a plurality of control signals CTRL to the buffer chip 200, and the controller 100 may transmit data DATA to the buffer chip 200 or receive data DATA from the buffer chip 200.

The buffer chip 200 may be disposed between the controller 100 and the first to fourth memory chips 310 to 340, and the buffer chip 200 may be electrically coupled to the controller 100 and the first to fourth memory chips 310 to 340. The buffer chip 200 may transfer the plurality of control signals CTRL and the data DATA provided from the controller 100 to the first to fourth memory chips 310 to 340, and transfer the data DATA output from the first to fourth memory chips 310 to 340 to the controller 100. In an embodiment, the buffer chip 200 may be electrically coupled between the controller 100 and the first to fourth memory chips 310 to 340.

The first to fourth memory chips 310 to 340 may perform operations corresponding to the plurality of control signals CTRL transferred through the buffer chip 200 from the controller 100, and may perform an operation of storing the data DATA therein and an operation of outputting the stored data therefrom.

The semiconductor system according to an embodiment may include the buffer chip 200. The buffer chip 200 may be configured to transfer the data output from the first to fourth memory chips 310 to 340 to the controller 100 or transfer the data output from one of the first to fourth memory chips 310 to 340 to other memory chips. The buffer chip 200 may be configured to perform a logic operation on the data output from the first to fourth memory chips and transfer the logic operation result to the controller 100 or one of the memory chips 310 to 340. The logic operation may include, for example but not limited to, an operation such as addition, subtraction, multiplication, and division for the data.

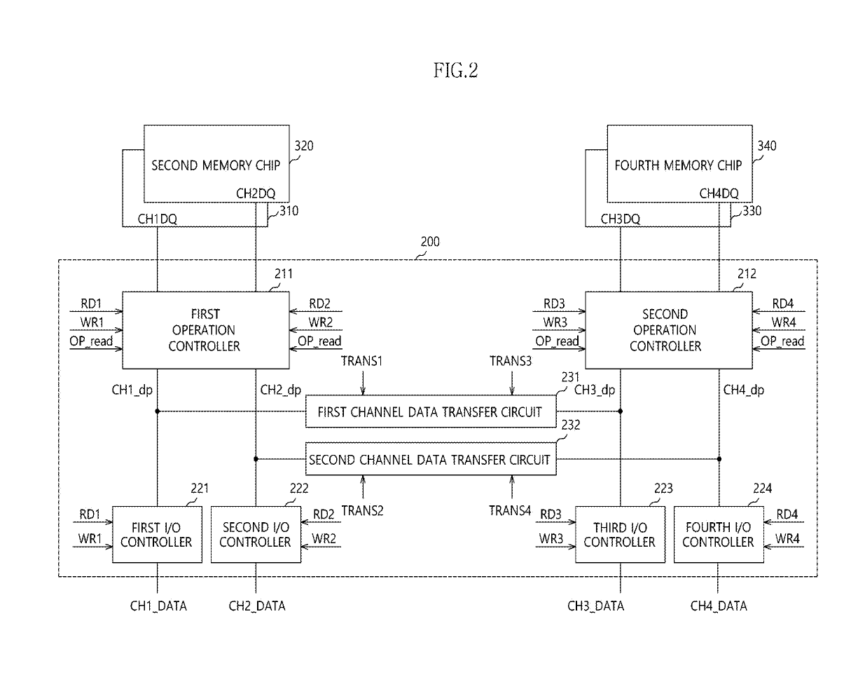

FIG. 2 is a diagram illustrating a representation of an example of a configuration of the buffer chip 200 and the memory chips 310 to 340 of the semiconductor system according to an embodiment.

The buffer chip 200 may be electrically coupled to the first to fourth memory chips 310 to 340. For example, the buffer chip 200 may be electrically coupled to a first chip data input/output (I/O) terminal CH1DQ of the first memory chip 310, a second chip data I/O terminal CH2DQ of the second memory chip 320, a third chip data I/O terminal CH3DQ of the third memory chip 330, and a fourth chip data I/O terminal CH4DQ of the fourth memory chip 340. In this example, the first memory chip 310 may input and output data through the first chip data I/O terminal CH1DQ. The second memory chip 320 may input and output data through the second chip data I/O terminal CH2DQ. The third memory chip 330 may input and output data through the third chip data I/O terminal CH3DQ. The fourth memory chip 340 may input and output data through the fourth chip data I/O terminal CH4DQ.

Referring to FIG. 2, the buffer chip 200 may include first and second operation controllers 211 and 212, first to fourth I/O controllers 221, 222, 223, and 224, and first and second channel data transfer circuits 231 and 232.

In response to first and second chip read signals RD1 and RD2, first and second chip write signals WR1 and WR2, and an operation read signal OP_read, the first operation controller 211 may output the data received from the first memory chip 310 and the data received from the second memory chip 320 as first chip preliminary data CH1_dp and second chip preliminary data CH2_dp or may perform logic operations on the data received from the first memory chip 310 and the data received from the second memory chip 320 and output the logic operation results as the first chip preliminary data CH1_dp and the second chip preliminary data CH2_dp. In response to the first and second chip read signals RD1 and RD2, the first and second chip write signals WR1 and WR2, and the operation read signal OP_read, the first operation controller 211 may output the first chip preliminary data CH1_dp and the second chip preliminary data CH2_dp input from the first and second I/O controllers 221 and 222 to the first and second memory chips 310 and 320. For example, when the first and second chip read signals RD1 and RD2 are enabled, the first operation controller 211 may output the data output from the first memory chip 310 and the data output from the second memory chip 320 as the first chip preliminary data CH1_dp and the second chip preliminary data CH2_dp. When the first and second chip read signals RD1 and RD2 are enabled and the operation read signal OP_read is enabled, the first operation controller 211 may perform a first logic operation on the data output from the first memory chip 310 and the data output from the second memory chip 320 and output the first logic operation result as the first chip preliminary data CH1_dp, and perform a second logic operation on the data output from the first memory chip 310 and the data output from the second memory chip 320 and output the second logic operation result as the second chip preliminary data CH2_dp. When the first and second chip write signals WR1 and WR2 are enabled, the first operation controller 211 may output the first chip preliminary data CH1_dp received from the first I/O controller 221 and the second chip preliminary data CH2_dp received from the second I/O controller 222 to the first and second memory chips 310 and 320.

In response to third and fourth chip read signals RD3 and RD4, third and fourth chip write signals WR3 and WR4, and the operation read signal OP_read, the second operation controller 212 may output the data received from the third memory chip 330 and the data received from the fourth memory chip 340 as third chip preliminary data CH3_dp and fourth chip preliminary data CH4_dp, or may perform logic operations on the data received from the third memory chip 330 and the data received from the fourth memory chip 340 and output the logic operation results as the third chip preliminary data CH3_dp and the fourth chip preliminary data CH4_dp. In response to the third and fourth chip read signals RD3 and RD4, the third and fourth chip write signals WR3 and WR4, and the operation read signal OP_read, the second operation controller 212 may output the third chip preliminary data CH3_dp and the fourth chip preliminary data CH4_dp input from the third and fourth I/O controllers 223 and 224 to the third and fourth memory chips 330 and 340. For example, when the third and fourth chip read signals RD3 and RD4 are enabled, the second operation controller 212 may output the data output from the third memory chip 330 and the data output from the fourth memory chip 340 as the third chip preliminary data CH3_dp and the fourth chip preliminary data CH4_dp. When the third and fourth chip read signals RD3 and RD4 are enabled and the operation read signal OP_read is enabled, the second operation controller 212 may perform a first logic operation on the data output from the third memory chip 330 and the data output from the fourth memory chip 340 and output a first logic operation result as the third chip preliminary data CH3_dp, and perform a second logic operation on the data output from the third memory chip 330 and the data output from the fourth memory chip 340 and output a second logic operation result as the fourth chip preliminary data CH4_dp. When the third and fourth chip write signals WR3 and WR4 are enabled, the second operation controller 212 may output the third chip preliminary data CH3_dp received from the third I/O controller 223 and the fourth chip preliminary data CH4_dp received from the fourth I/O controller 224 to the third and fourth memory chips 330 and 340.

In response to the first chip read signal RD1 and the first chip write signal WR1, the first I/O controller 221 may output first chip data CH1_DATA as the first chip preliminary data CH1_dp or output the first chip preliminary data CH1_dp as the first chip data CH1_DATA. For example, when the first chip write signal WR1 is enabled, the first I/O controller 221 may output the first chip data CH1_DATA as the first chip preliminary data CH1_dp. When the first chip read signal RD1 is enabled, the first I/O controller 221 may output the first chip preliminary data CH1_dp as the first chip data CH1_DATA. In this example, the first chip preliminary data CH1_dp may refer to data exchanged between the first operation controller 211 and the first I/O controller 221, and the first chip data CH1_DATA may refer to data exchanged between the first I/O controller 221 and the controller (see 100 of FIG. 1).

In response to the second chip read signal RD2 and the second chip write signal WR2, the second I/O controller 222 may output second chip data CH2_DATA as the second chip preliminary data CH2_dp or output the second chip preliminary data CH2_dp as the second chip data CH2_DATA. For example, when the second chip write signal WR2 is enabled, the second I/O controller 222 may output the second chip data CH2_DATA as the second chip preliminary data CH2_dp. When the second chip read signal RD2 is enabled, the second I/O controller 222 may output the second chip preliminary data CH2_dp as the second chip data CH2_DATA. In this example, the second chip preliminary data CH2_dp may refer to data exchanged between the first operation controller 211 and the second I/O controller 222, and the second chip data CH2_DATA may refer to data exchanged between the second I/O controller 222 and the controller 100.

In response to the third chip read signal RD3 and the third chip write signal WR3, the third I/O controller 223 may output third chip data CH3_DATA as the third chip preliminary data CH3_dp or output the third chip preliminary data CH3_dp as the third chip data CH3_DATA. For example, when the third chip write signal WR3 is enabled, the third I/O controller 223 may output the third chip data CH3_DATA as the third chip preliminary data CH3_dp. When the third chip read signal RD3 is enabled, the third I/O controller 223 may output the third chip preliminary data CH3_dp as the third chip data CH3_DATA. In this example, the third chip preliminary data CH3_dp may refer to data exchanged between the second operation controller 212 and the third I/O controller 223, and the third chip data CH3_DATA may refer to data exchanged between the third I/O controller 223 and the controller 100.

In response to the fourth chip read signal RD4 and the fourth chip write signal WR4, the fourth I/O controller 224 may output fourth chip data CH4_DATA as the fourth chip preliminary data CH4_dp or output the fourth chip preliminary data CH4_dp as the fourth chip data CH4_DATA. For example, when the fourth chip write signal WR4 is enabled, the fourth I/O controller 224 may output the fourth chip data CH4_DATA as the fourth chip preliminary data CH4_dp. When the fourth chip read signal RD4 is enabled, the fourth I/O controller 224 may output the fourth chip preliminary data CH4_dp as the fourth chip data CH4_DATA. In this example, the fourth chip preliminary data CH4_dp may refer to data exchanged between the second operation controller 212 and the fourth I/O controller 224, and the fourth chip data CH4_DATA may refer to data exchanged between the fourth I/O controller 224 and the controller 100.

The first channel data transfer circuit 231 may output the first chip preliminary data CH1_dp as the third chip preliminary data CH3_dp or output the third chip preliminary data CH3_dp as the first chip preliminary data CH1_dp in response to first and third chip transfer signals TRANS1 and TRANS3. For example, when the first chip transfer signal TRANS1 is enabled, the first channel data transfer circuit 231 may transfer the first chip preliminary data CH1_dp as the third chip preliminary data CH3_dp to the second operation controller 212 and the third I/O controller 223. When the third chip transfer signal TRANS3 is enabled, the first channel data transfer circuit 231 may transfer the third chip preliminary data CH3_dp as the first chip preliminary data CH1_dp to the first operation controller 211 and the first I/O controller 221.

The second channel data transfer circuit 232 may output the second chip preliminary data CH2_dp as the fourth chip preliminary data CH4_dp or output the fourth chip preliminary data CH4_dp as the second chip preliminary data CH2_dp in response to second and fourth chip transfer signals TRANS2 and TRANS4. For example, when the second chip transfer signal TRANS2 is enabled, the second channel data transfer circuit 232 may transfer the second chip preliminary data CH2_dp as the fourth chip preliminary data CH4_dp to the second operation controller 212 and the fourth I/O controller 224. When the fourth chip transfer signals TRANS4 is enabled, the second channel data transfer circuit 232 may transfer the fourth chip preliminary data CH4_dp as the second chip preliminary data CH2_dp to the first operation controller 211 and the second I/O controller 222.

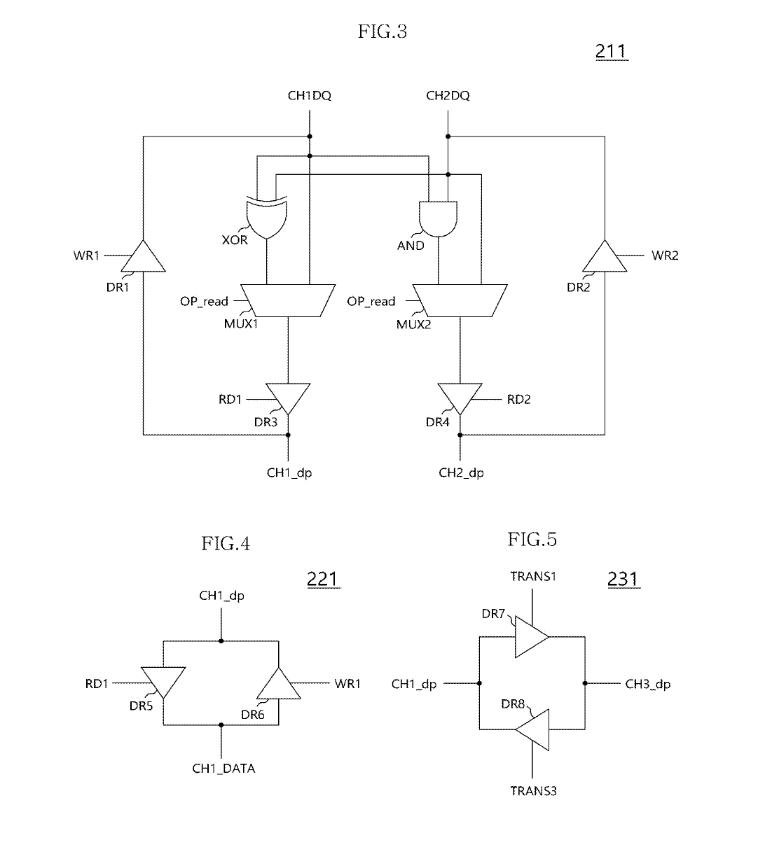

Referring to FIG. 3, the first operation controller 211 may include first to fourth drivers DR1, DR2, DR3, and DR4, first and second multiplexers MUX1 and MUX2, a first logic operation element XOR, and a second logic operation element AND.

When the first chip write signal WR1 is enabled, the first driver DR1 may be activated and output the first chip preliminary data CH1_dp to the first chip data I/O terminal CH1DQ of the first memory chip 310.

When the second chip write signal WR2 is enabled, the second driver DR1 may be activated and output the second chip preliminary data CH2_dp to the second chip data I/O terminal CH2DQ of the second memory chip 320.

The first logic operation element XOR may perform the first logic operation on data output from the first chip data I/O terminal CH1DQ and data output from the second chip data I/O terminal CH2DQ and output the first logic operation result. For example, the first logic operation element XOR may include an exclusive OR (XOR) gate. The first logic operation element XOR may output an output signal of a low level when the data output from the first chip data I/O terminal CH1DQ is identical with the data output from the second chip data I/O terminal CH2DQ, and output an output signal of a high level when the data output from the first chip data I/O terminal CH1DQ is different from the data output from the second chip data I/O terminal CH2DQ.

The second logic operation element AND may perform the second logic operation on the data output from the first chip data I/O terminal CH1DQ and the data output from the second chip data I/O terminal CH2DQ and output the second logic operation result. For example, the second logic operation element AND may include an AND gate. The second logic operation element AND may output an output signal of a high level when the data output from the first chip data I/O terminal CH1DQ and the data output from the second chip data I/O terminal CH2DQ are a high level, and output an output signal of a low level when any one of the data output from the first chip data I/O terminal CH1DQ and the data output from the second chip data I/O terminal CH2DQ is a low level.

The first multiplexer MUX1 may output one of the output signal of the first logic operation element XOR and the output signal of the first chip data I/O terminal CH1DQ in response to the operation read signal OP_read. For example, when the operation read signal OP_read is enabled, the first multiplexer MUX1 may output the output signal of the first logic operation element XOR as an output signal. When the operation read signal OP_read is disabled, the first multiplexer MUX1 may output the signal output from the first chip data I/O terminal CH1DQ as the output signal.

The second multiplexer MUX2 may output one of the output signal of the second logic operation element AND and the output signal of the second chip data I/O terminal CH2DQ in response to the operation read signal OP_read. For example, when the operation read signal OP_read is enabled, the second multiplexer MUX2 may output the output signal of the second logic operation element AND as an output signal. When the operation read signal OP_read is disabled, the second multiplexer MUX2 may output the signal output from the second chip data I/O terminal CH2DQ as the output signal.

When the first chip read signal DR1 is enabled, the third driver DR3 may be activated and output the output signal of the first multiplexer MUX1 as the first chip preliminary data CH1_dp.

When the second chip read signal DR2 is enabled, the fourth driver DR4 may be activated and output the output signal of the second multiplexer MUX2 as the second chip preliminary data CH2_dp.

In a write operation of the first memory chip 310, that is, when the first chip write signal WR1 is enabled, the first operation controller 211 having the above-described configuration according to an embodiment may provide the first chip preliminary data CH1_dp to the first chip data I/O terminal CH1DQ through the first driver DR1, and the first memory chip 310 may receive the first chip preliminary data CH1_dp as data through the first chip data I/O terminal CH1DQ. In a write operation of the second memory chip 320, that is, when the second chip write signal WR2 is enabled, the first operation controller 211 may provide the second chip preliminary data CH2_dp to the second chip data I/O terminal CH2DQ through the second driver DR2, and the second memory chip 320 may receive the second chip preliminary data CH2_dp as data through the second chip data I/O terminal CH2DQ. In a read operation of the first memory chip 310, that is, when the first chip read signal RD1 is enabled and the operation read signal OP_read is disabled, the first operation controller 211 may output the data output from the first chip data I/O terminal CH1DQ of the first memory chip 310 as the first chip preliminary data CH1_dp. In a read operation of the second memory chip 320, that is, when the second chip read signal RD2 is enabled and the operation read signal OP_read is disabled, the first operation controller 211 may output the data output from the second chip data I/O terminal CH2DQ of the second memory chip 320 as the second chip preliminary data CH2_dp. In an operation read operation, that is, when the first and second chip read signals RD1 and RD2 are enabled and the operation read signal OP_read is enabled, the first operation controller 211 may perform the first and second logic operations on the data output from the first chip data I/O terminal CH1DQ of the first memory 310 and the data output from the second chip data I/O terminal CH2DQ of the second memory chip 320, and may output the first logic operation result as the first chip preliminary data CH1_dp and output the second logic operation result as the second chip preliminary data CH2_dp.

The second operation controller 212 has a difference from the first operation controller 211 in that the input and output signals are different from those of the first operation controller 211, but the configuration and operation of the second operation controller 212 may be the same as those of the first operation controller 211. Therefore, description for the configuration of the second operation controller 212 will be omitted, and the operation of the second operation controller 212 will be described below.

In a write operation of the third memory chip 330, that is, when the third chip write signal WR3 is enabled, the second operation controller 212 may provide the third chip preliminary data CH3_dp to the third chip data I/O terminal CH3DQ, and the third memory chip 330 may receive the third chip preliminary data CH3_dp as data through the third chip data I/O terminal CH3DQ. In a write operation of the fourth memory chip 340, that is, when the fourth chip write signal WR4 is enabled, the second operation controller 212 may provide the fourth chip preliminary data CH4_dp to the fourth chip data I/O terminal CH4DQ, and the fourth memory chip 340 may receive the fourth chip preliminary data CH4_dp as data through the fourth chip data I/O terminal CH4DQ. In a read operation of the third memory chip 330, that is, when the third chip read signal RD3 is enabled and the operation read signal OP_read is disabled, the second operation controller 212 may output the data output from the third chip data I/O terminal CH3DQ of the third memory chip 330 as the third chip preliminary data CH3_dp. In a read operation of the fourth memory chip 340, that is, when the fourth chip read signal RD4 is enabled and the operation read signal OP_read is disabled, the second operation controller 212 may output the data output from the fourth chip data I/O terminal CH4DQ of the fourth memory chip 340 as the fourth chip preliminary data CH4_dp. In an operation read operation, that is, when the third and fourth chip read signals RD3 and RD4 are enabled and the operation read signal OP_read is enabled, the second operation controller 212 may perform the first and second logic operations on the data output from the third chip data I/O terminal CH3DQ of third memory chip 330 and the data output from the fourth chip data I/O terminal CH4DQ of the fourth memory chip 340, and may output the first logic operation result as the third chip preliminary data CH3_dp and output the second logic operation result as the fourth chip preliminary data CH4_dp.

Referring to FIG. 4, the first I/O controller 221 may include a fifth driver DR5 and a sixth driver DR6.

When the first chip read signal RD1 is enabled, the fifth driver DR5 may be activated and output the first chip preliminary data CH1_dp as the first chip data CH1_DATA.

When the first chip write signal WR1 is enabled, the sixth driver DR6 may be activated and output the first chip data CH1_DATA as the first chip preliminary data CH1_dp.

The second to fourth I/O controllers 222 to 224 have differences from the first I/O controller 221 in that the input and output signals are different from those of the first I/O controller 221, but configurations of the second to fourth I/O controllers 222 to 224 may be the same as that of the first I/O controller 221.

Referring to FIG. 5, the first channel data transfer circuit 231 may include a seventh driver DR7 and an eighth driver DR8.

When the first chip transfer signal TRANS1 is enabled, the seventh driver DR7 may be activated and output the first chip preliminary data CH1_dp as the third chip preliminary data CH3_dp.

When the third chip transfer signal TRANS3 is enabled, the eighth driver DR8 may be activated and output the third chip preliminary data CH3_dp as the first chip preliminary data CH1_dp.

The second channel data transfer circuit 232 has differences from the first channel data transfer circuit 231 in that the input and output signals are different from those of the first channel data transfer circuit 231, but the configuration of the second channel data transfer circuit 232 may be the same as that of the first channel data transfer circuit 231.

An operation of the semiconductor system having an above-described configuration according to an embodiment will be described below.

An operation of outputting the data output from the first memory chip 310 as the first chip data CH1_DATA to the controller 100 through the buffer chip 200 will be described.

The first memory chip 310 may output the data through the first chip data I/O terminal CH1DQ, and the data output from the first memory chip 310 may be input to the first operation controller 211 of the buffer chip 200.

In a state that the first chip read signal RD1 is enabled and the operation read signal OP_read is disabled, the first operation controller 211 may output the data input from the first chip data I/O terminal CH1DQ as the first chip preliminary data CH1_dp.

When the first chip read signal RD1 is enabled, the first I/O controller 221 may provide the first chip preliminary data CH1_dp as the first chip data CH1_DATA to the controller 100.

An operation of outputting the data output from the second memory chip 320 as the second chip data CH2_DATA to the controller 100 through the buffer chip 200 will be described.

The second memory chip 320 may output the data through the second chip data I/O terminal CH2DQ, and the data output from the second memory chip 320 may be input to the first operation controller 211 of the buffer chip 200.

In a state that the second chip read signal RD2 is enabled and the operation read signal OP_read is disabled, the first operation controller 211 may output the data input from the second chip data I/O terminal CH2DQ as the second chip preliminary data CH2_dp.

When the second chip read signal RD2 is enabled, the second I/O controller 222 may provide the second chip preliminary data CH2_dp as the second chip data CH2_DATA to the controller 100.

An operation of outputting the data output from the third memory chip 330 as the third chip data CH3_DATA to the controller 100 through the buffer chip 200 will be described.

The third memory chip 330 may output the data through the third chip data I/O terminal CH3DQ, and the data output from the third memory chip 330 may be input to the second operation controller 212 of the buffer chip 200.

In a state that the third chip read signal RD3 is enabled and the operation read signal OP_read is disabled, the second operation controller 212 may output the data input from the third chip data I/O terminal CH3DQ as the third chip preliminary data CH3_dp.

When the third chip read signal RD3 is enabled, the third I/O controller 223 may provide the third chip preliminary data CH3_dp as the third chip data CH3_DATA to the controller 100.

An operation of outputting the data output from the fourth memory chip 340 as the fourth chip data CH4_DATA to the controller 100 through the buffer chip 200 will be described.

The fourth memory chip 340 may output the data through the fourth chip data I/O terminal CH4DQ, and the data output from the fourth memory chip 340 may be input to the second operation controller 212 of the buffer chip 200.

In a state that the fourth chip read signal RD4 is enabled and the operation read signal OP_read is disabled, the second operation controller 212 may output the data input from the fourth chip data I/O terminal CH4DQ as the fourth chip preliminary data CH4_dp.

When the fourth chip read signal RD4 is enabled, the fourth I/O controller 224 may provide the fourth chip preliminary data CH4_dp as the fourth chip data CH4_DATA to the controller 100.

An operation of transferring the logic operation results on the data output from the first memory chip 310 and the data output from the second memory chip 320 to the controller 100 or the third and fourth memory chips 330 and 340 will be described.

The data output from the first memory chip 310 through the first chip data I/O terminal CH1DQ and the data output from the second memory chip 320 through the second chip data I/O terminal CH2DQ may be input to the first operation controller 211 of the buffer chip 200.

When the operation read signal OP_read is enabled in a state that the first and second chip read signals RD1 and RD2 are enabled, the first operation controller 211 may perform the first logic operation on the data input from the first chip data I/O terminal CH1DQ and the data input from the second chip data I/O terminal CH2DQ and output the first logic operation result as the first chip preliminary data CH1_dp, and the first operation controller 211 may perform the second logic operation on the data input from the first chip data I/O terminal CH1DQ and the data input from the second chip data I/O terminal CH2DQ and output the second logic operation result as the second chip preliminary data CH2_dp.

The first chip preliminary data CH1_dp including the first logic operation result and the second chip preliminary data CH2_dp including the second logic operation result may be provided to the controller 100 through the first and second I/O controllers 221 and 222.

The first chip preliminary data CH1_dp including the first logic operation result and the second chip preliminary data CH2_dp including the second logic operation result may be provided to the third and fourth memory chips 330 and 340 through the first and second channel data transfer circuits 231 and 232.

When the first chip transfer signal TRANS1 is enabled, the first channel data transfer circuit 231 may output the first chip preliminary data CH1_dp as the third chip preliminary data CH3_dp.

When the second chip transfer signal TRANS2 is enabled, the second channel data transfer circuit 232 may output the second chip preliminary data CH2_dp as the fourth chip preliminary data CH4_dp.

The second operation controller 212 which receives the enabled third and fourth write signals WR3 and WR4 may provide the third chip preliminary data CH3_dp to the third memory chip 330 and provide the fourth chip preliminary data CH4_dp to the fourth memory chip 340.

Accordingly, the logic operation results on the data output from the first memory chip 310 and the data output from the second memory chip 320 may be provided to the third and fourth memory chips 330 and 340 and stored in the third and fourth memory chips 330 and 340.

An operation of transferring the logic operation results on the data output from the third memory chip 330 and the data output from the fourth memory chip 340 to the controller 100 or the first and second memory chips 310 and 320 will be described.

The data output from the third memory chip 330 through the third chip data I/O terminal CH3DQ and the data output from the fourth memory chip 340 through the fourth chip data I/O terminal CH4DQ may be input to the second operation controller 212 of the buffer chip 200.

When the operation read signal OP_read is enabled in a state that the third and fourth chip read signals RD3 and RD4 are enabled, the second operation controller 212 may perform the first logic operation on the data input from the third chip data I/O terminal CH3DQ and the data input from the fourth chip data I/O terminal CH4DQ and output the first logic operation result as the third chip preliminary data CH3_dp, and the second operation controller 212 may perform the second logic operation on the data input from the third chip data I/O terminal CH3DQ and the data input from the fourth chip data I/O terminal CH4DQ and output the second logic operation result as the fourth chip preliminary data CH4_dp.

The third chip preliminary data CH3_dp including the first logic operation result and the fourth chip preliminary data CH4_dp including the second logic operation result may be provided to the controller 100 through the third and fourth I/O controllers 223 and 224.

The third chip preliminary data CH3_dp including the first logic operation result and the fourth chip preliminary data CH4_dp including the second logic operation result may be provided to the first and second memory chips 310 and 320 through the first and second channel data transfer circuits 231 and 232.

When the third chip transfer signal TRANS3 is enabled, the first channel data transfer circuit 231 may output the third chip preliminary data CH3_dp as the first chip preliminary data CH1_dp.

When the fourth chip transfer signal TRANS4 is enabled, the second channel data transfer circuit 232 may output the fourth chip preliminary data CH4_dp as the second chip preliminary data CH2_dp.

The first operation controller 211 which receives the enabled first and second write signals WR1 and WR2 may provide the first chip preliminary data CH1_dp to the first memory chip 310 and provide the second chip preliminary data CH2_dp to the second memory chip 320.

Accordingly, the logic operation results on the data output from the third memory chip 330 and the data output from the fourth memory chip 340 may be provided to the first and second memory chips 310 and 320 and stored in the first and second memory chips 310 and 320.

An operation of providing the first to fourth chip data CH1_DATA, CH2_DATA, CH3_DATA, and CH4_DATA to the first to fourth memory chips 310 to 340 will be described.

The first to fourth chip data CH1_DATA, CH2_DATA, CH3_DATA, and CH4_DATA may be provided from the controller 100 to the buffer chip 200.

The first to fourth I/O controllers 221 to 224 may provide the first to fourth chip data CH1_DATA, CH2_DATA, CH3_DATA, and CH4_DATA as the first to fourth chip preliminary data CH1_dp, CH2_dp, CH3_dp, and CH4_dp to the first and second operation controllers 211 and 212 in response to the enabled first to fourth chip write signals WR1, WR2, WR3, and WR4.

The first operation controller 211 which receives the enabled first and second write signals WR1 and WR2 may provide the first chip preliminary data CH1_dp to the first memory chip 310 and provide the second chip preliminary data CH2_dp to the second memory chip 320.

The second operation controller 212 which receives the enabled third and fourth write signals WR3 and WR4 may provide the third chip preliminary data CH3_dp to the third memory chip 330 and provide the fourth chip preliminary data CH4_dp to the fourth memory chip 340.

The semiconductor system according to an embodiment may provide pieces of data to the memory chips or provide pieces of data from the memory chips to the controller or may perform logic operations on the pieces of data output from the memory chips and provide the logic operation results to the controller or other memory chips other than the memory chips which output the pieces of data.

An embodiment illustrated in FIG. 2 has been used to describe a semiconductor system where one chip data I/O terminal is provided to each of the memory chips. However, a plurality of chip data I/O terminals may be provided to each of the memory chips, and the configuration of the circuit provided in the buffer chip may be changed according to the plurality of chip data I/O terminals.

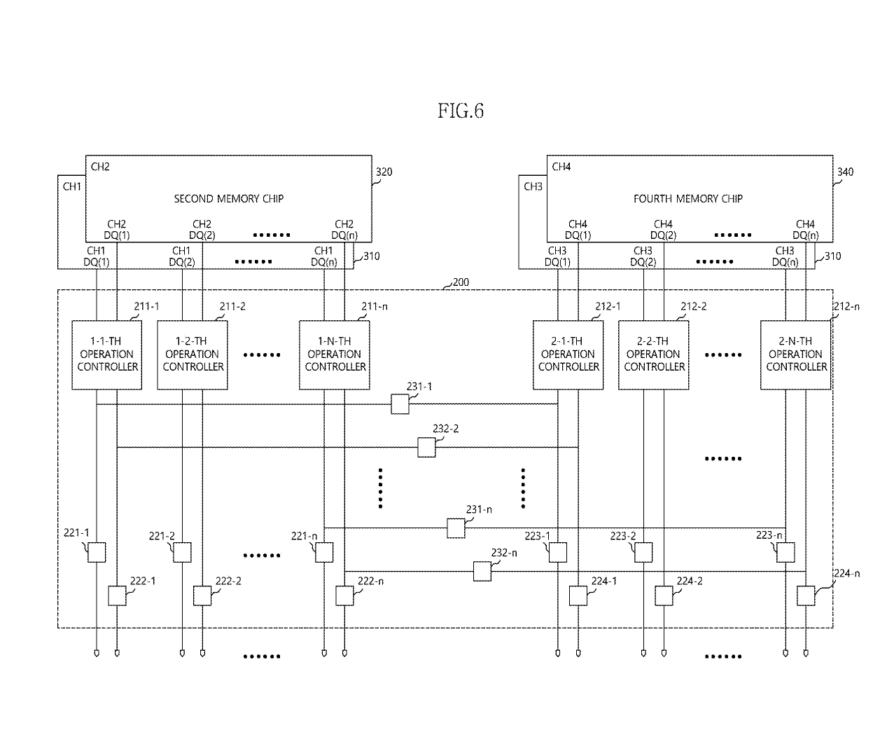

FIG. 6 illustrates a representation of an example of an example of a semiconductor system in which each of memory chips 310, 320, 330, and 340 includes a plurality of chip data I/O terminals according to an embodiment.

The first memory chip 310 may include a plurality of chip data I/O terminals CH1DQ(1) to CH1DQ(n).

The second memory chip 320 may include a plurality of chip data I/O terminals CH2DQ(1) to CH2DQ(n).

The third memory chip 330 may include a plurality of chip data I/O terminals CH3DQ(1) to CH3DQ(n).

The fourth memory chip 340 may include a plurality of chip data I/O terminals CH4DQ(1) to CH4DQ(n).

A plurality of first operation controllers 211-1 to 211-n, that is, a 1-1-th operation controller 211-1 to a 1-n-th operation controller 211-n may be coupled to corresponding chip data I/O terminals among the plurality of chip data I/O terminals CH1DQ(1) to CH1DQ(n) and CH2DQ(1) to CH2DQ(n) included in the first and second memory chips 310 and 320.

A plurality of first I/O controllers 221-1 to 221-n and a plurality of second I/O controllers 222-1 to 222-n may be coupled to corresponding operation controllers among the plurality of first operation controllers 211-1 to 211-n.

A plurality of second operation controllers 212-1 to 212-n, that is, a 2-1-th operation controller 212-1 to a 2-n-th operation controller 212-n may be coupled to corresponding chip data I/O terminals among the plurality of chip data I/O terminals CH3DQ(1) to CH3DQ(n) and CH4DQ(1) to CH4DQ(n) included in the third and fourth memory chips 330 and 340.

A plurality of third I/O controllers 223-1 to 223-n and a plurality of fourth I/O controllers 224-1 to 224-n may be coupled to corresponding operation controllers among the plurality of second operation controllers 212-1 to 212-n.

A plurality of first channel data transfer circuits 231-1 to 231-n and a plurality of second channel data transfer circuits 232-1 to 232-n may be coupled to corresponding operation controllers among the plurality of first operation controllers 211-1 to 211-n and the plurality of second operation controllers 212-1 to 212-n.

The plurality of first operation controllers 211-1 to 211-n and the plurality of second operation controllers 212-1 to 212-n may have the same configurations as the first operation controller 211 and the second operation controller 212 of FIG. 2 and may perform the same operations as the first operation controller 211 and the second operation controller 212. The plurality of first I/O controllers 221-1 to 221-n, the plurality of second I/O controllers 222-1 to 222-n, the plurality of third I/O controllers 223-1 to 223-n, and the plurality of fourth I/O controllers 224-1 to 224-n may have the same configurations as the first I/O controller 221, the second I/O controller 222, the third I/O controller 223, and the fourth I/O controller 224 of FIG. 2 and may perform the same operations as the first I/O controller 221, the second I/O controller 222, the third I/O controller 223, and the fourth I/O controller 224.

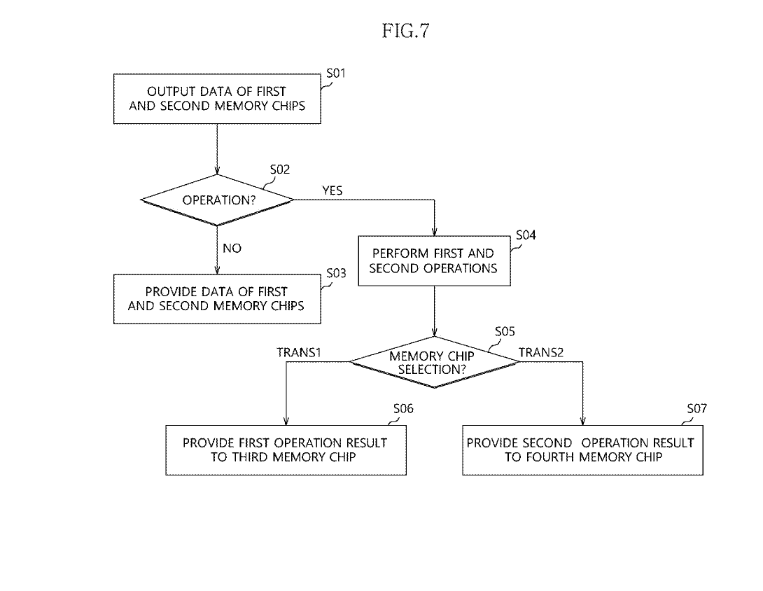

A controlling method of the semiconductor system according to an embodiment illustrated in FIG. 2 will be described, for example, with reference to FIG. 7.

Data may be output from the first and second memory chips 310 and 320 (S01).

It may be determined whether or not to perform an operation on the data output from the first memory chip 310 and the data output from the second memory chip 320 in response to the operation read signal OP_read (S02).

When the operation read signal OP_read is disabled (i.e., NO), the data output from the first memory chip 310 and the data output from the second memory chip 320 may be provided to the controller (see 100 of FIG. 1) (S03).

When the operation read signal OP_read is enabled (i.e., YES), first and second operations on the data output from the first memory chip 310 and the data output from the second memory chip 320 may be performed (S04). The first operation may be the XOR logic operation illustrated in FIG. 3, and the second operation may be the AND logic operation illustrated in FIG. 3.

Memory chips to which the first and second operation results are to be provided may be selected in response to the first chip transfer signal TRANS1 and the second chip transfer signal TRANS2 (S05).

When the first chip transfer signal TRANS1 is enabled, the first operation result may be provided to the first memory chip 330 (S06).

When the second chip transfer signal TRANS2 is enabled, the second operation result may be provided to the fourth memory chip 340 (S07). Referring to FIG. 2, the first chip read signal RD1 and the first chip write signal WR1 may be signals controlled through the controller 100 in the read and write operations of the first memory chip 310. The second chip read signal RD2 and the second write signal WR2 may be signals controlled through the controller 100 in the read and write operations of the second memory chip 320. The third chip read signal RD3 and the third chip write signal WR3 may be signals controlled through the controller 100 in the read and write operations of the third memory chip 330. The fourth chip read signal RD4 and the fourth write signal WR4 may be signals controlled through the controller 100 in the read and write operations of the fourth memory chip 340.

The above embodiments are illustrative and not limitative. Various alternatives and equivalents are possible. The embodiments are not limited by the embodiments described herein. Nor are the embodiments limited to any specific type of semiconductor device. Other additions, subtractions, or modifications are obvious in view of the present disclosure and are intended to fall within the scope of the appended claims.

What is claimed is:

1. A semiconductor system comprising:
a controller;
a buffer chip electrically coupled to the controller; and
a plurality of memory chips electrically coupled to the buffer chip,
wherein the buffer chip is configured to perform logic operations on data output from at least one pair of memory chips among the plurality of memory chips, and to output the logic operation results to the controller or provide the logic operation results to other memory chips among the plurality of memory chips other than the at least one pair of memory chips which output the data.

2. The semiconductor system of claim 1, wherein the plurality of memory chips include first to fourth memory chips, and
the buffer chip includes:
a first operation controller electrically coupled to the first and second memory chips;
a second operation controller electrically coupled to the third and fourth memory chips;
a first input/output (I/O) controller electrically coupled to the first operation controller;
a second I/O controller electrically coupled to the first operation controller;
a third I/O controller electrically coupled to the second operation controller;
a fourth I/O controller electrically coupled to the second operation controller;
a first channel data transfer circuit configured to electrically couple a node in which the first operation controller and the first I/O controller are coupled and a node in which the second operation controller and the third I/O controller are coupled; and
a second channel data transfer circuit configured to electrically couple a node in which the first operation controller and the second I/O controller are coupled and a node in which the second operation controller and the fourth I/O controller are coupled.

3. The semiconductor system of claim 2, wherein the first operation controller is configured to transfer data input from the first memory chip and data input from the second memory chip to the first I/O controller and the second I/O controller or to perform the logic operations on the data input from the first memory chip and the data input from the second memory chip and output the logic operation results to the first I/O controller and the second I/O controller.

4. The semiconductor system of claim 3, wherein the first operation controller is configured to perform an EXCLUSIVE OR OPERATION and an AND OPERATION on the data input from the first memory chip and the data input from the second memory chip.

5. The semiconductor system of claim 3, wherein in response to an operation read signal, the first operation controller is configured to perform a first logic operation on the data input from the first memory chip and the data input from the second memory chip and transfer a first logic operation result to the first I/O controller, and to perform a second logic operation on the data input from the first memory chip and the data input from the second memory chip and transfer a second logic operation result to the second I/O controller.

6. The semiconductor system of claim 5, wherein when the operation read signal is enabled, the first operation controller is configured to perform the first logic operation on the data input from the first memory chip and the data input from the second memory chip and transfer the first logic operation result to the first I/O controller, and to perform the second logic operation on the data input from the first memory chip and the data input from the second memory chip and transfer the second logic operation result to the second I/O controller, and
when the operation read signal is disabled, the first operation controller is configured to transfer the data input from the first memory chip and the data input from the second memory chip to the first I/O controller and the second I/O controller, respectively.

7. The semiconductor system of claim 6, wherein each of the first and second I/O controllers is configured to provide a signal input from the first operation controller to the controller or output a signal input from the controller to the first operation controller.

8. The semiconductor system of claim 2, wherein the second operation controller is configured to transfer data input from the third memory chip and data input from the fourth memory chip to the third I/O controller and the fourth I/O controller or to perform the logic operations on the data input from the third memory chip and the data input from the fourth memory chip and output the logic operation results to the third I/O controller and the fourth I/O controller.

9. The semiconductor system of claim 8, wherein the second operation controller is configured to perform an exclusive or operation and an and operation on the data input from the third memory chip and the data input from the fourth memory chip.

10. The semiconductor system of claim 8, wherein in response to an operation read signal, the second operation controller is configured to perform a first logic operation on the data input from the third memory chip and the data input from the fourth memory chip and transfer a first logic operation result to the third I/O controller, and to perform a second logic operation on the data input from the third memory chip and the data input from the fourth memory chip and transfer a second logic operation result to the fourth I/O controller.

11. The semiconductor system of claim 10, wherein when the operation read signal is enabled, the second operation controller is configured to perform the first logic operation on the data input from the third memory chip and the data input from the fourth memory chip and transfer the first logic operation result to the third I/O controller, and to perform the second logic operation on the data input from the third memory chip and the data input from the fourth memory chip and transfer the second logic operation result to the fourth I/O controller, and
when the operation read signal is disabled, the second operation controller is configured to transfer the data input from the third memory chip and the data input from the fourth memory chip to the third I/O controller and the fourth I/O controller, respectively.

12. The semiconductor system of claim 11, wherein each of the third and fourth I/O controllers is configured to provide a signal input from the second operation controller to the controller or output a signal input from the controller to the second operation controller.

13. The semiconductor system of claim 2, wherein each of the first and second channel data transfer circuits is configured to transfer an output of the first operation controller to an input of the second operation controller or transfer an output of the second operation controller to an input of the first operation controller.

14. The semiconductor system of claim 1, wherein the plurality of memory chips are stacked over the buffer chip.

15. A method of controlling a semiconductor system, the method comprising:
outputting data from a first memory chip and a second memory chip;
determining whether or not to perform an operation;
providing the data output from the first memory chip and the data output from the second memory chip to a controller when it is determined that the operation is not performed;
performing a first operation and a second operation on the data output from the first memory chip and the data output from the second memory chip when it is determined that the operation is performed; and
selecting memory chips to which results of the first operation and the second operation are to be transferred.

16. The method of claim 15, wherein the determining whether or not to perform the operation includes determining whether or not to perform the operation in response to an operation read signal provided from the controller.

17. The method of claim 15, wherein the performing of the first operation and the second operation includes performing the first operation and the second operation, which are different from each other, on the data output from the first memory chip and the data output from the second memory chip.

18. The method of claim 15, wherein the semiconductor system further includes a third memory chip and a fourth memory chip, and
the selecting of the memory chips to which the results for the first operation and the second operation are to be transferred includes:
providing the result for the first operation to the third memory chip when a first chip transfer signal is enabled; and
providing the result for the second operation to the fourth memory chip when a second chip transfer signal is enabled.
